(19) United States
(12) Patent Application Publication
(10) Pub. No.: US 2026/0239007 A1
(43) Pub. Date: Aug. 13, 2026

(54) APPLICATION PROGRAMMING INTERFACE (API) INVOKER AUTHENTICATION

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/048,518

(22) Filed: Feb. 7, 2025

(51) Int. Cl. H04W 12/069

(52) U.S. Cl. CPC H04W 12/069

(57) ABSTRACT

Various aspects of the present disclosure relate to application programming interface (API) invoker authentication. An API invoker/UE transmits an onboard API invoker request including a UE identifier, a first authentication code, and a first freshness parameter. The API invoker/UE receives an onboard API invoker response including an API invoker certificate associated with the UE identifier and one or more application identifiers (A-IDs), and an API invoker secret associated with the UE identifier and one or more A-IDs.

### TECHNICAL FIELD

The present disclosure relates to wireless communications, and more specifically to application programming interfaces (APIs) in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit an onboard application programming interface (API) invoker request including a UE identifier, a first authentication code, and a first freshness parameter; and receive an onboard API invoker response including an API invoker certificate associated with the UE identifier and one or more application identifiers (A-IDs), and an API invoker secret associated with the UE identifier and one or more A-IDs.

A processor (e.g., a standalone processor chipset, or a component of a UE) for wireless communication is described. The processor may be configured to, capable of, or operable to perform one or more operations as described herein. For example, the processor may be configured to, capable of, or operable to transmit an onboard API invoker request including a UE identifier, a first authentication code, and a first freshness parameter; and receive an onboard API invoker response including an API invoker certificate associated with the UE identifier and one or more A-IDs, and an API invoker secret associated with the UE identifier and one or more A-IDs.

A method performed or performable by a UE for wireless communication is described. The method may include transmitting an onboard API invoker request including a UE identifier, a first authentication code, and a first freshness parameter; and receiving an onboard API invoker response including an API invoker certificate associated with the UE identifier and one or more A-IDs, and an API invoker secret associated with the UE identifier and one or more A-IDs.

In some implementations of the UE, the processor, and the method described herein, the UE identifier includes one or more of a generic public subscription identifier (GPSI) or a subscription permanent identifier (SUPI), and the first freshness parameter includes one or more of a nonce number, a random number, or a counter.

In some implementations of the UE, the processor, and the method described herein, the onboard API invoker request further includes one or more of an authentication and key management for applications (AKMA) Key Identifier (A-KID) or a routing indicator.

In some implementations of the UE, the processor, and the method described herein, the routing indicator includes routing information to route verification of the first authentication code to one or more of a network function or an application function.

In some implementations of the UE, the processor, and the method described herein, the UE, the processor, and the method may further be configured to, capable of, operable to, performed to, or performable to generate the first authentication code as one or more of: a hash of one or more of a UE security context, the UE identifier, the first freshness parameter, the routing indicator, the A-KID, or an A-ID; or a message authentication code (MAC) of one or more of the UE security context, the UE identifier, the first freshness parameter, the routing indicator, the A-KID, or the A-ID.

In some implementations of the UE, the processor, and the method described herein, the UE security context includes one or more of an authentication server function (AUSF) key, an AKMA key, or an application function (AF) key.

In some implementations of the UE, the processor, and the method described herein, the UE, the processor, and the method may further be configured to, capable of, operable to, performed to, or performable to transmit an offboard API invoker request including the UE identifier, a third authentication code, and a second freshness parameter; and receive, based at least in part on the offboard API invoker request, an offboard API invoker response.

A first network entity (e.g., a NE, a network function, an infrastructure component) for wireless communication is described. The first network entity may be configured to, capable of, or operable to perform one or more operations as described herein. For example, the first network entity may be configured to, capable of, or operable to receive an onboard API invoker request including a UE identifier, a first authentication code, and a first freshness parameter; communicate a first UE identifier verification request including the UE identifier, one or more of the first authentication code or an authentication code indication, and the first freshness parameter; receive a first UE identifier verification response based at least in part on information included in the first UE identifier verification request; and transmit, based at least in part on the first UE identifier verification response, an onboard API invoker response.

A processor (e.g., a standalone processor chipset, or a component of a network entity) for wireless communication is described. The processor may be configured to, capable of, or operable to perform one or more operations as described herein. For example, the processor may be configured to, capable of, or operable to receive an onboard API invoker request including a UE identifier, a first authentication code, and a first freshness parameter; communicate a first UE identifier verification request including the UE identifier, one or more of the first authentication code or an authentication code indication, and the first freshness parameter; receive a first UE identifier verification response based at least in part on information included in the first UE identifier verification request; and transmit, based at least in part on the first UE identifier verification response, an onboard API invoker response.

A method performed or performable by a first network entity (e.g., a NE, a network function, an infrastructure component) for wireless communication is described. The method may include receiving an onboard API invoker request including a UE identifier, a first authentication code, and a first freshness parameter; communicating a first UE identifier verification request including the UE identifier, one or more of the first authentication code or an authentication code indication, and the first freshness parameter; receiving a first UE identifier verification response based at least in part on information included in the first UE identifier verification request; and transmitting, based at least in part on the first UE identifier verification response, an onboard API invoker response.

In some implementations of the first network entity, the processor, and the method described herein, the onboard API invoker request further includes one or more of an A-KID or a routing indicator, and where the first UE identifier verification request is communicated based at least in part on the one or more of the A-KID or the routing indicator.

In some implementations of the first network entity, the processor, and the method described herein, the first UE identifier verification response includes an indication of whether the first authentication code is successfully verified.

In some implementations of the first network entity, the processor, and the method described herein, the first UE identifier verification response includes the UE identifier and a second authentication code, and the first network entity, the processor, and the method may further be configured to, capable of, operable to, performed to, or performable to verify the first authentication code based at least in part on a comparison of the first authentication code to the second authentication code.

In some implementations of the first network entity, the processor, and the method described herein, the first network entity, the processor, and the method may further be configured to, capable of, operable to, performed to, or performable to generate an API invoker profile for the UE identifier based at least in part on a GPSI and one or more A-IDs.

In some implementations of the first network entity, the processor, and the method described herein, the onboard API invoker response includes an onboard secret associated with the UE identifier and one or more A-IDs.

In some implementations of the first network entity, the processor, and the method described herein, the first network entity, the processor, and the method may further be configured to, capable of, operable to, performed to, or performable to receive an offboard API invoker request including the UE identifier, a third authentication code, and a second freshness parameter; communicate a second UE identifier verification request including the UE identifier, the third authentication code, and the second freshness parameter; receive a second UE identifier verification response based at least in part on information included in the second UE identifier verification request; and transmit, based at least in part on the second UE identifier verification response, an offboard API invoker response.

A second network entity (e.g., a NE, a network function, an infrastructure component) for wireless communication is described. The second network entity may be configured to, capable of, or operable to perform one or more operations as described herein. For example, the second network entity may be configured to, capable of, or operable to receive a UE identifier verification request including a UE identifier, a first authentication code, and a first freshness parameter; generate a second authentication code based at least in part on the UE identifier and a UE security context associated with the UE identifier; and communicate a UE identifier verification response based at least in part on the second authentication code.

A processor (e.g., a standalone processor chipset, or a component of a network entity) for wireless communication is described. The processor may be configured to, capable of, or operable to perform one or more operations as described herein. For example, the processor may be configured to, capable of, or operable to receive a UE identifier verification request including a UE identifier, a first authentication code, and a first freshness parameter; generate a second authentication code based at least in part on the UE identifier and a UE security context associated with the UE identifier; and communicate a UE identifier verification response based at least in part on the second authentication code.

A method performed or performable by a second network entity (e.g., a NE, a network function, an infrastructure component) for wireless communication is described. The method may include receiving a UE identifier verification request including a UE identifier, a first authentication code, and a first freshness parameter; generating a second authentication code based at least in part on the UE identifier and a UE security context associated with the UE identifier; and communicating a UE identifier verification response based at least in part on the second authentication code.

In some implementations of the second network entity, the processor, and the method described herein, the second authentication code is generated based at least in part on a security context associated with the UE identifier.

In some implementations of the second network entity, the processor, and the method described herein, the second network entity, the processor, and the method may further be configured to, capable of, operable to, performed to, or performable to verify the first authentication code based at least in part on a comparison of the first authentication code to the second authentication code.

In some implementations of the second network entity, the processor, and the method described herein, the UE identifier verification response includes an indication of whether the first authentication code is successfully verified.

In some implementations of the second network entity, the processor, and the method described herein, the UE identifier verification response includes the second authentication code.

### BRIEF DESCRIPTION OF THE DRAWINGS

FIG. 1 illustrates an example of a wireless communications system in accordance with aspects of the present disclosure.

FIG. 2 illustrates a security information flow for the API invoker onboarding procedure.

FIG. 3 illustrates an example signaling diagram in accordance with aspects of the present disclosure.

FIG. 4 illustrates an example signaling diagram in accordance with aspects of the present disclosure.

FIG. 5 illustrates a signaling diagram in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method in accordance with aspects of the present disclosure.

FIG. 10 illustrates a flowchart of a method in accordance with aspects of the present disclosure.

FIG. 11 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. A wireless communications system may utilize time-frequency resources to expose different functionalities to UEs and other devices, such as via APIs. A common API framework (CAPIF) can be used to manage access of API invokers (e.g., UEs, other devices) to APIs.

In an existing CAPIF system (e.g., in a 3GPP network), the API invokers can be onboarded (e.g., registered) to the CAPIF system by performing an onboarding procedure with the CAPIF Core Function (CCF). Following a successful onboarding procedure, an API invoker can be able to request access to API exposure services. An API invoker can be an application/client which resides in an UE or resides externally, such as an application functions/application server. In cases where the API invoker resides in the UE, existing API invoker onboarding procedures can experience challenges. For example, for the API invoker residing as part of the UE, the API invoker can invoke service API exposure requests via the CAPIF system to obtain UE related data/service data. When the API invoker indicates a UE ID (e.g., GPSI) in a service request (e.g., onboard API invoker request or access token request related to service API exposures) to the CCF, some wireless communications system do not provide a means to verify if the API invoker resides as part of the UE related to the GPSI indicated in the request. This can lead to API invokers falsely claiming to be residing in an identified UE and causing denial of service to the UEs, e.g., by onboarding with a GPSI related to another UE and consuming that UE's service related data by exploiting the API service exposure.

Implementations described herein include solutions to verify UE identifier authentication by the CCF during an API invoker onboarding procedure to confirm that the API invoker is residing in an identified UE as indicated/claimed by the API invoker. The CCF can provides an authentication code received from the UE to a function in the network (e.g., Network Function (NF), AUSF, AF, AKMA Anchor Function (AAnF)) to verify the authentication code. Implementations also provide solutions to verify the UE identifier/authentication by the CCF during an API invoker onboarding procedure to confirm that the API invoker is residing in the identified UE as indicated/claimed by the API invoker. The CCF can provide the inputs to generate an authentication code based on the inputs received from the API invoker to the function in the network (e.g., core NF, AUSF, AF, AAnF) and fetch the authentication code to verify the authentication code. The CCF, for example, can check if the authentication code received from the function in the network matches with an authentication code provided by the API invoker. Implementations also provide solutions to verify the API invoker identifier/authentication by the CCF during an API invoker offboarding procedure to confirm that the API invoker is residing in the identified UE as indicated/claimed by the API invoker.

By performing the described techniques, secure access to APIs in wireless communications systems can be provided, which can reduce unauthorized API access and reduce access of API resources (e.g., time/frequency resources) by unauthorized API invokers.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

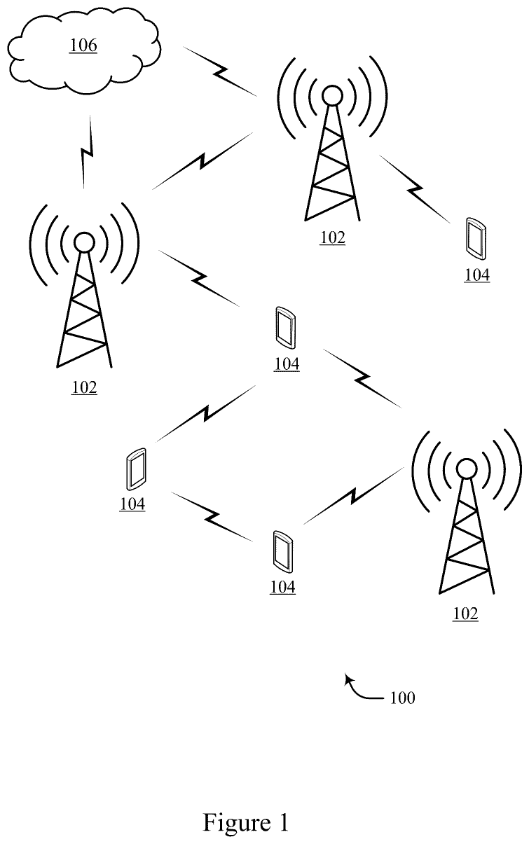

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 transmits an onboard API invoker request including a UE identifier, a first authentication code, and a first freshness parameter. The UE 104 receives an onboard API invoker response including an API invoker certificate associated with the UE identifier and one or more A-IDs, and an API invoker secret associated with the UE identifier and one or more A-IDs.

A first network entity (e.g., a NE, a network function, an infrastructure component) receives an onboard API invoker request including a UE identifier, a first authentication code, and a first freshness parameter, and communicates a first UE identifier verification request including the UE identifier, one or more of the first authentication code or an authentication code indication, and the first freshness parameter. The first network entity receives a first UE identifier verification response based at least in part on information included in the first UE identifier verification request, and transmits, based at least in part on the first UE identifier verification response, an onboard API invoker response.

A second network entity (e.g., a NE, a network function, an infrastructure component) receives a UE identifier verification request including a UE identifier, a first authentication code, and a first freshness parameter, and generates a second authentication code based at least in part on the UE identifier and a UE security context associated with the UE identifier. The second network entity communicates a UE identifier verification response based at least in part on the second authentication code.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to security procedures for API invoker onboarding, the API invoker and the CCF follow the procedure in this subclause to secure and authenticate the onboarding of the API invoker to the CCF. (See 3GPP Technical Specification (TS) 33.122). The API invoker and the CCF can establish a secure session using Transport Layer Security (TLS). Security profiles for TLS implementation and usage can follow the provisions given in TS 33.310, Annex E.

With a secure session established, the API invoker sends an onboard API invoker request message to the CCF. The onboard API invoker request message carries an onboard credential obtained during pre-provisioning of the onboard enrolment information, which may be an OAuth 2.0 access token. When the OAuth 2.0 token based mechanism is used as the onboarding credential, the access token shall be encoded as JSON web token as specified in Internet Engineering Task Force (IETF) RFC 7519, shall include the JSON web signature as specified in IETF RFC 7515, and shall be validated per OAuth 2.0, IETF RFC 7519 and IETF RFC 7515. Other credentials may also be used (e.g., message digest).

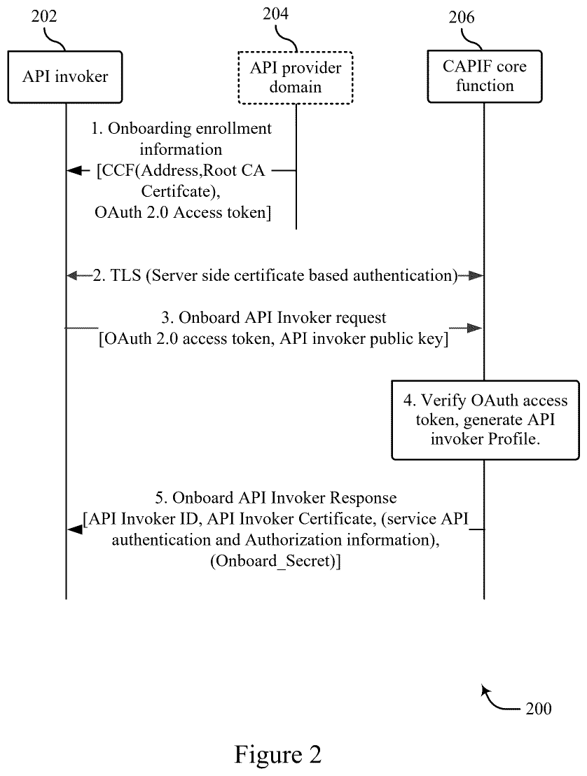

FIG. 2 illustrates a security information flow 200 for the API invoker onboarding procedure. The OAuth 2.0 token based authentication credential is shown in this example. The security information flow 200 includes an API invoker 202, an API provider domain 204, and a CCF 206. In implementations, an API invoker can refer to a UE and/or functionality that resides on a UE or other device that determines to invoke an API.

At Step 1, as a prerequisite to the onboarding procedure, the API invoker 202 obtains onboarding enrolment information from the API provider domain 204. The onboarding enrolment information is used to authenticate and establish a secure TLS communication with the CCF 206 during the onboarding process. The enrolment information includes details of the CCF 206 (Address, and Root CA certificate) and includes an onboarding credential (the OAuth 2.0 access token).

At Step 2, the API invoker 202 and CCF 206 establish a secure session based on TLS (Server side certificate authentication). The API invoker 202 uses the enrolment information obtained in Step 1 to establish the TLS session with the CCF 206. At Step 3, after successful establishment of the TLS session, the API invoker 202 sends an onboard API invoker request message to the CCF 206 along with the enrolment credential (OAuth 2.0 access token). The API invoker 202 generates the key pair {Private Key, Public key} and provides the public key along with the onboard API invoker request.

At Step 4, the CCF 206 validates the enrolment credential (OAuth 2.0 access token). If validation of the credential (the OAuth 2.0 access token in this example) is successful, the CCF 206 generates an API invoker's profile as specified in TS 23.222 (as incorporated herein) which may include the selected method for application exposing function (AEF) authentication and authorization between the API invoker 202 and the AEF (see subclause 6.5.2 of TS 23.222). The CCF 206 may generate API invoker's certificate on its own, for the assigned API invoker identity and public key. This certificate can be used by the API invoker 202 for subsequent authentication procedures with the CCF 206 and may be used for establishing a secure connection and authentication with the API Exposing Function. The CCF 206 may optionally generate an Onboard_Secret. The Onboard_Secret value remains the same during the lifetime of the onboarding, and can be bound to the CCF specific API invoker ID.

When API invoker's client certificate is issued by the third party, then in Step 3 the API invoker 202 can additionally include the certificate in onboard API invoker request message. If the CCF 206 trusts the issuer of the API invoker's client certificate, then the CCF 206 includes the provided certificate in the API invoker's profile, in Step 4. It is up to the CAPIF domain policy to accept the client certificates issued by third party. At Step 5, the CCF 206 can respond with an onboard API invoker response message. The response can include the CCF assigned API invoker ID, AEF Authentication and authorization information (if generated in Step 4), API invoker's certificate, and the API invoker Onboard_Secret (if generated by the CCF).

A number of security issues may arise with API invoker onboarding and offboarding. As one example, a malicious API invoker may impersonate victim API invoker to do the onboarding/offboarding. To mitigate security issues, the CCF shall be able to support onboarding/offboarding of the API invoker residing in the UE, and the CCF shall be able to authenticate the API invoker residing in the UE.

In some wireless communications systems, validation of correct GPSI in API invoker information is considered. GPSI provided by the API invoker in an onboarding or modification request is to be confirmed to be associated to the UE on which the API invoker is running. One option enables the CCF to validate apiInvokerInformation details (e.g., information about an API invoker, examples of which are described herein) by UE interaction. The API invoker requests UE to create a MAC (Message Authentication Code) for the apiInvokerInformation or the GPSI as a proof that the GPSI belongs to this UE. Such MAC is to be generated out of information known to both the UE and the 5GC. During onboarding, update, and/or modify request to the CCF, the API invoker sends the MAC provided by the UE in addition to the apiInvokerInformation, e.g., application and device details (GPSI, etc.). Upon receiving the onboarding/update/modify request, the CCF requests the 5GC to also generate the MAC on the apiInvokerInformation that the CCF is to communicate for this action. The CCF receives a MAC result and compares both MACs. The CCF can processes the request if the MACs successfully match.

Some issues with such approaches are that to use AKMA key for the MAC generation, the correct AAnF which is holding the AAnF is to be identified by A-KID (e.g., AKMA AF will be able to identify the AAnF serving the UE from the A-KID.) Such approaches thus may not function acceptable, as there may not be sufficient information provided by the API invoker to enable the CCF reach the correct AAnF to fetch the AKMA key for the MAC generation. Additionally, the MAC generation at the UE and network side is not clear, and can lead to same MAC generation if multiple onboarding/offboarding happens during the lifetime of same AUSF or AKMA key.

In some wireless communications systems, onboarding, offboarding, and authentication of API invokers residing on a UE are considered. Clause 6.1 of TS 33.122 can be considered with the following changes for the onboarding of the API invoker residing on a UE. The API invoker service provider (e.g., a backend server of the application service provider (ASP) who also provides the API invoker) issues an access token including the Application identifier for the API invoker. The onboarding enrolment information known by the CCF includes the certificate of the service provider of the API invoker or one of the certificates in the certificate chain for the certificate of service provider of the API invoker. CAPIF provider domain can also have the information about which applications are provided by the API invoker service provider and corresponding application identifiers.

Regarding the security information flow 200, in Step 3 of the security information flow 200, the API invoker sends the access token issued by the API invoker service provider to the CCF and can also send the certificate of the API invoker service provider to the CCF. In Step 3, the UE hosting the API invoker can be authenticated by the CCF. For example, UE ID Token issued by a UE ID Server in the network can be used. In Step 4, the CCF verifies the token and checks whether the API invoker service provider provides the application identified by the Application identifier in the access token. If the check is successful, the CCF also stores the Application identifier of the API invoker in the API invoker profile in the CCF. In Step 4, if the UE hosting the API invoker is authenticated by the CCF then the CCF can store the UE identifier in the API invoker profile in the CCF. Some issues with such approaches are that the UE ID token issuance or generation is not described to clarify how the CCF will be able to authenticate the UE. How the CCF gains access to an authenticated UE ID related to the UE ID token is also not described which may result in such solutions not being fully functional.

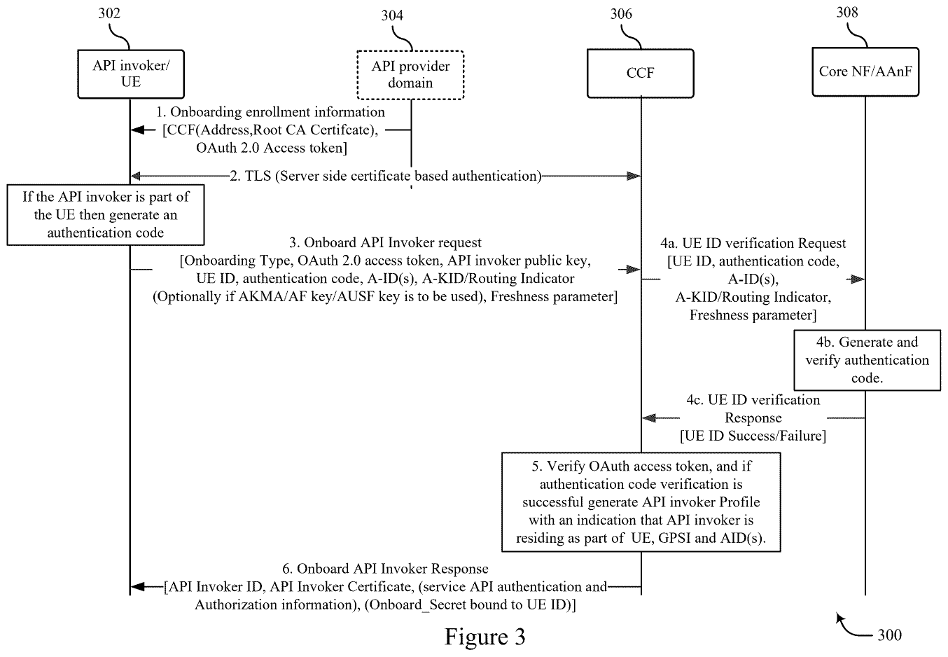

FIG. 3 illustrates an example signaling diagram 300 in accordance with aspects of the present disclosure. The signaling diagram 300 describes example procedures to verify the UE identifier/authentication by the CCF during an API invoker onboarding procedure to confirm that the API invoker is residing in the specific UE as indicated/claimed by the API invoker. In implementations, CCF provides the authentication code received from the UE to the function in the network (core NF/AUSF/AF/AAnF) to verify if the received authentication code is correct. The authentication code can be an information computed (e.g., using hash/MAC of set of inputs including the UE ID (e.g., GPSI/SUPI) and freshness parameter known to the UE and the core network function/3GPP network). Alternatively, or in addition, an authentication code can be referred to as UE security context identification information which assists the CCF to securely identify and verify if a UE security context exists for the UE in the network, where the UE has the API invoker residing in it and performs API invoker onboarding.

The API invoker and the CCF can follow procedures to secure and authenticate the onboarding of the API invoker and authentication of the related UE (e.g., the UE where the API invoker resides, which can also be referred to as a hosting UE) to the CCF. The API invoker and the CCF can establish a secure session using TLS. With a secure session established, the API invoker sends an onboard API invoker request message to the CCF. The onboard API invoker request message carries an onboard credential obtained during pre-provisioning of the onboard enrolment information, which may be an OAuth 2.0 access token. When the OAuth 2.0 token based mechanism is used as the onboarding credential, the access token can be encoded as a JSON web token as specified in IETF RFC 7519, can include the JSON web signature as specified in IETF RFC 7515, and can be validated per OAuth 2.0, IETF RFC 7519 and IETF RFC 7515. Other credentials may also be used (e.g., message digest).

In the signaling diagram 300, at Step 1 an API invoker/UE 302 (e.g., UE) obtains onboarding enrolment information from an API provider domain 304. The onboarding enrolment information is used to authenticate and establish a secure TLS communication with a CCF 306 during the onboarding process. The enrolment information includes details of the CCF 306 (Address, and Root CA certificate) and includes an onboarding credential (the OAuth 2.0 access token). At Step 2, the API invoker/UE 302 and CCF 306 establish a secure session based on TLS (Server side certificate authentication). The API invoker/UE 302 can use the enrolment information obtained in Step 1 to establish the TLS session with the CCF 306.

At Step 3, after successful establishment of the TLS session, the API invoker/UE 302 can send an onboard API invoker request message to the CCF 306 along with the onboarding type (‘User/Subscriber Indication/UE service based’), enrolment credential (OAuth 2.0 access token), UE ID (e.g., GPSI/SUPI), authentication code, Application Identifier(s) (A-ID(s)), AKMA Key Identifier (A-KID)/Routing Indicator (e.g., to route the authentication code verification related request to the right NF/AF in the network to fetch a related UE security context related to UE ID e.g., a NF can be an AUSF or AAnF or it can an AF), and a freshness parameter which can be used in the authentication code generation. A freshness parameter, for example, can be implemented as one or more of a nonce number, a random number, or a counter. In examples, the freshness parameter can indicate a recency of authentication information, such as with reference to a threshold. For example, if a freshness parameter exceeds a threshold, authentication information may be identified as stale. The API invoker/UE 302 can generate the key pair {Private Key, Public key} and provide the public key along with the onboard API invoker request.

In examples, the authentication code can be generated as Hash and/or MAC using different information such as UE security context, UE ID (e.g., GPSI/SUPI), freshness parameter (e.g., Nonce/Random number/Counter), Routing Indicator/A-KID, A-ID(s)), etc. A UE security context used in the authentication code generation can be AUSF key, AKMA Key, or AF Key, respectively. AKMA AF/AF can identify the AAnF serving the UE from the A-KID to fetch the AF key or a related AKMA key for the authentication code generation.

At Step 4a, the CCF 306 sends a request (e.g., UE ID verification request/authentication verification request) to a Core NF/AAnF/AF 308 which includes the UE ID (e.g., GPSI/SUPI), authentication code, Application Identifier(s) (A-ID(s)), AKMA Key Identifier (A-KID)/Routing Indicator (e.g., to route the authentication code verification related request to the right NF/AF in the network), and freshness parameter (used in the authentication code generation) as received from the API invoker/UE. The CCF 306 can use the routing indicator/A-KID received from the API invoker/UE 302 to send the request (e.g., UE ID verification request/authentication verification request) to the correct Core NF/AAnF/AF 308 which holds the UE context (e.g., AUSF key, AKMA Key or AF Key related to the Application identifier) related to the UE ID (e.g., GPSI/SUPI).

At Step 4b, the Core NF/AAnF/AF 308 fetches the UE security context (AUSF key, AKMA Key or AF Key) related to the UE ID (e.g., GPSI/SUPI) and generates the authentication similar to the API invoker/UE 302. At Step 4c, the Core NF/AAnF/AF 308 sends a response (e.g., UE ID verification response/authentication verification response) to the CCF 306 with success indication if the authentication code received in step 4a from the CCF 306 matches the authentication code computed in Step 4b. Alternatively, a failure indication is sent in response if the authentication code received in Step 4a from the CCF 306 do not matches the authentication code computed locally. The CCF 306, based on received failure indication, considers the UE identification verification as failure and the onboarding of the API invoker fails.

At Step 5, if the CCF 306 receives a success indication in response message from the core NF/AAnF/AF 308, the CCF 306 validates the enrolment credential (e.g., OAuth 2.0 access token). If validation of the credential (e.g., the OAuth 2.0 access token in this example) is successful, the CCF 306 can generate an API invoker's profile which may include a selected method for AEF authentication and authorization between the API invoker/UE 302 and the AEF and along with the UE ID (e.g., SUPI/GPSI) and the A-ID(s). The CCF 306 may generate API invoker's certificate for the assigned API invoker identity and public key and the certificate can also include the UE ID (e.g., SUPI/GPSI) and the A-ID(s) e.g., subject name, device name/identifier, or a field in the certificate can include the UE ID and/or A-ID respectively. The certificate can be used by the API invoker/UE 302 for subsequent authentication procedures with the CCF 306 and may be used for establishing a secure connection and authentication with the API Exposing Function. The CCF 306 may optionally generate an Onboard_Secret for CAPIF-2e security. The Onboard_Secret value remains the same during the lifetime of the onboarding, and can be bound to the CCF specific API invoker ID, the related UE ID (e.g., SUPI/GPSI) and the respective A-ID(s).

When an API invoker client certificate is issued by the third party, then at Step 3, the API invoker/UE 302 can additionally include the certificate in the onboard API invoker request message. If the CCF 306 trusts the issuer of the API invoker's client certificate, then the CCF 306 can include the provided certificate in the API invoker's profile in Step 4. CAPIF domain policy may determine whether to accept the client certificates issued by third party.

At Step 6, the CCF 306 can respond with an onboard API invoker response message. The response can include the CCF assigned API invoker ID, AEF Authentication and authorization information (if generated in Step 4), API invoker's certificate (with the related UE ID (e.g., SUPI/GPSI), the respective A-ID(s)), and the API invoker Onboard_Secret bound to the related UE ID (e.g., SUPI/GPSI) and the respective A-ID(s) (e.g., if generated by the CCF 306).

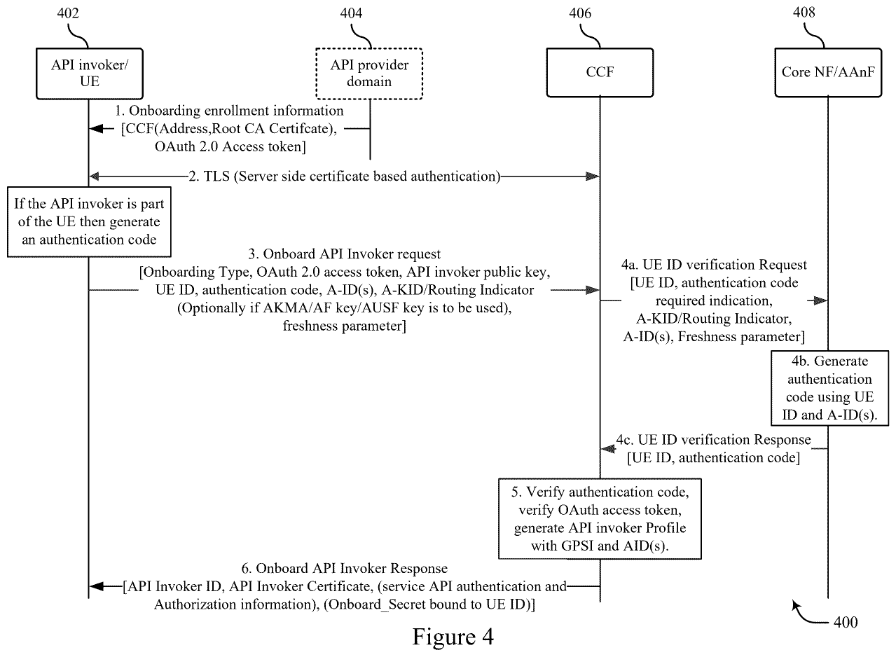

FIG. 4 illustrates an example signaling diagram 400 in accordance with aspects of the present disclosure. The signaling diagram 400 describes example procedures to verify the UE identifier authentication by the CCF during an API invoker onboarding procedure to confirm that the API invoker is residing in the specific UE as indicated/claimed by the API invoker. In this implementation, the CCF provides the input received from the UE related to authentication code generation to the function in the network (e.g., core NF/AUSF/AF/AAnF) to compute and receive the authentication code in order to verify if the received authentication code from the UE matches with the authentication code received from the function in the network. The authentication code can be information computed (e.g., using hash/MAC of set of inputs including the UE ID (e.g., GPSI/SUPI) and freshness parameter known to the UE and the core network function/3GPP network). Alternatively, or in addition, an authentication code can be referred to as a UE security context, which can represent identification information which assists the CCF to securely identify and verify if a UE security context exists for the UE in the network, where the UE has the API invoker residing at the UE and performs API invoker onboarding.

In implementations, the API invoker and the CCF follow procedures to secure and authenticate the onboarding of the API invoker and authentication of the related UE (e.g., the UE where the API invoker resides, which can also be referred to as a hosting UE) to the CCF. The API invoker and the CCF can establish a secure session using TLS.

With a secure session established, the API invoker sends an onboard API invoker request message to the CCF. The onboard API invoker request message carries an onboard credential obtained during pre-provisioning of the onboard enrolment information, which may be an OAuth 2.0 access token. When the OAuth 2.0 token based mechanism is used as the onboarding credential, the access token can be encoded as JSON web token, such as specified in IETF RFC 7519, which can include the JSON web signature as specified in IETF RFC 7515, and can be validated per OAuth 2.0, IETF RFC 7519 and IETF RFC 7515. Other credentials may also be used (e.g., message digest).

In the signaling diagram 400, at Step 1, an API invoker/UE 402 obtains onboarding enrolment information from an API provider domain 404. The onboarding enrolment information is used to authenticate and establish a secure TLS communication with a CCF 406 during the onboarding process. The enrolment information includes details of the CCF 406 (Address, and Root CA certificate) and includes an onboarding credential (e.g., OAuth 2.0 access token). At Step 2, the API invoker/UE 402 and CCF 406 can establish a secure session based on TLS (e.g., server side certificate authentication). The API invoker/UE 402 can use the enrolment information obtained in Step 1 to establish the TLS session with the CCF 406.

At Step 3, after successful establishment of the TLS session, the API invoker/UE 402 can send an onboard API invoker request message to the CCF 406 along with the onboarding type (‘User/Subscriber Indication/UE service based’), enrolment credential (OAuth 2.0 access token), UE ID (e.g., GPSI/SUPI), authentication code, Application Identifier(s) (A-ID(s)), AKMA Key Identifier (A-KID)/Routing Indicator (e.g., to route the authentication code verification related request to the correct NF/AF in the network to fetch a related UE security context related to UE ID, e.g., a NF can be an AUSF, AAnF, an AF), and/or a freshness parameter which can be used in the authentication code generation. The API invoker/UE 402 generates the key pair {Private Key, Public key} and provides the public key along with the onboard API invoker request. An authentication code can be generated as Hash and/or MAC using different information such as UE security context, UE ID (e.g., GPSI/SUPI), freshness parameter (e.g., Nonce/Random number/Counter), a routing Indicator/A-KID, and/or A-ID(s)). UE security context used in the authentication code generation can be one or more of AUSF key, AKMA Key, or AF Key, respectively. AKMA AF/AF can identify the AAnF serving the UE from the A-KID to fetch the AF key or a related AKMA key for the authentication code generation.

At Step 4a, the CCF 406 sends a request (e.g., UE ID verification request, authentication verification request) to a Core NF/AAnF/AF 408 which includes the UE ID (e.g., GPSI/SUPI), authentication code indication, Application Identifier(s) (A-ID(s)), AKMA Key Identifier (A-KID)/Routing Indicator (e.g., to route the authentication code verification related request to the correct NF/AF in the network), and/or freshness parameter (e.g., used in the authentication code generation), as received from the API invoker/UE. The CCF 406 can use the routing indicator/A-KID received from the API invoker/UE 402 to send the request (e.g., UE ID verification request, authentication verification request) to the correct Core NF/AAnF/AF which holds the UE context (e.g., AUSF key, AKMA Key or AF Key related to the Application identifier) related to the UE ID (e.g., GPSI/SUPI).

At Step 4b, the Core NF/AAnF/AF 408 fetches the UE security context (AUSF key, AKMA Key, or AF Key) related to the UE ID (e.g., GPSI/SUPI) and generates the authentication code similar to the API invoker/UE as described in Step 3 of the signaling diagram 400. At Step 4c, the Core NF/AAnF/AF 408 sends a response (e.g., UE ID verification response, authentication verification response) to the CCF 406 with the authentication code based on the received authentication code indication.

At Step 5, the CCF 406 receives an authentication code in response message from the Core NF/AAnF/AF 408, and the CCF 406 checks if the authentication code received in Step 4c from the Core NF/AAnF/AF 408 matches the authentication code received in Step 3 from the API invoker/UE 402. If the match is successful, the CCF 406 validates the enrolment credential (e.g., OAuth 2.0 access token). If validation of the credential (e.g., the OAuth 2.0 access token in this example) is successful, the CCF 406 can generate an API invoker's profile which may include the selected method for AEF authentication and authorization between the API invoker and the AEF and along with the UE ID (e.g., SUPI/GPSI) and the A-ID(s). The CCF 406 may generate API invoker's certificate for the assigned API invoker identity and public key, and the certificate can also include the UE ID (e.g., SUPI/GPSI) and the A-ID(s) e.g., subject name or device name/identifier or a suitable field in the certificate can include the UE ID and/or A-ID respectively. This certificate can be used by the API invoker/UE 402 for subsequent authentication procedures with the CCF and may be used for establishing a secure connection and authentication with the API Exposing Function.

The CCF 406 may optionally generate an Onboard_Secret if the subscribed Service API uses procedures for CAPIF-2e security. The Onboard_Secret value remains the same during the lifetime of the onboarding, and can be bound to the CCF specific API invoker ID, the related UE ID (e.g., SUPI/GPSI), and the respective A-ID(s). Alternatively, or in addition, if the CCF 406 determines that the authentication code received in Step 4c from the Core NF/AAnF/AF 408 do not match the authentication code received in Step 3 from the API invoker/UE 402, then the UE identification verification is considered as failed and the onboarding of the API invoker/UE 402 fails.

When the API invoker's client certificate is issued by the third party, then at Step 3, the API invoker/UE 402 can additionally include the certificate in onboard API invoker request message. If the CCF 406 trusts the issuer of the API invoker's client certificate, then the CCF 406 includes the provided certificate in the API invoker's profile in Step 4. CAPIF domain policy may determine whether to accept the client certificates issued by third party.

At Step 6, The CCF 406 can respond with an onboard API invoker response message. The response can include the CCF assigned API invoker ID, AEF Authentication and authorization information (if generated in Step 4), API invoker's certificate (with the related UE ID (e.g., SUPI/GPSI) and the respective A-ID(s)) and the API invoker Onboard_Secret bound to the related UE ID (e.g., SUPI/GPSI) and the respective A-ID(s) (if generated by the CCF).

Implementations also provide for verifying the UE identifier/authentication by the CCF during an API invoker offboarding procedure to confirm that the API invoker is residing in a specific UE as indicated/claimed by the API invoker while the API invoker requests to offboard from the CCF. Alternatively, or in addition, an authentication code can be referred to as a UE security context, which can represent identification information which assists the CCF to securely identify and verify if a UE security context exists for the UE in the network, where the UE has the API invoker within the UE and performs API invoker onboarding.

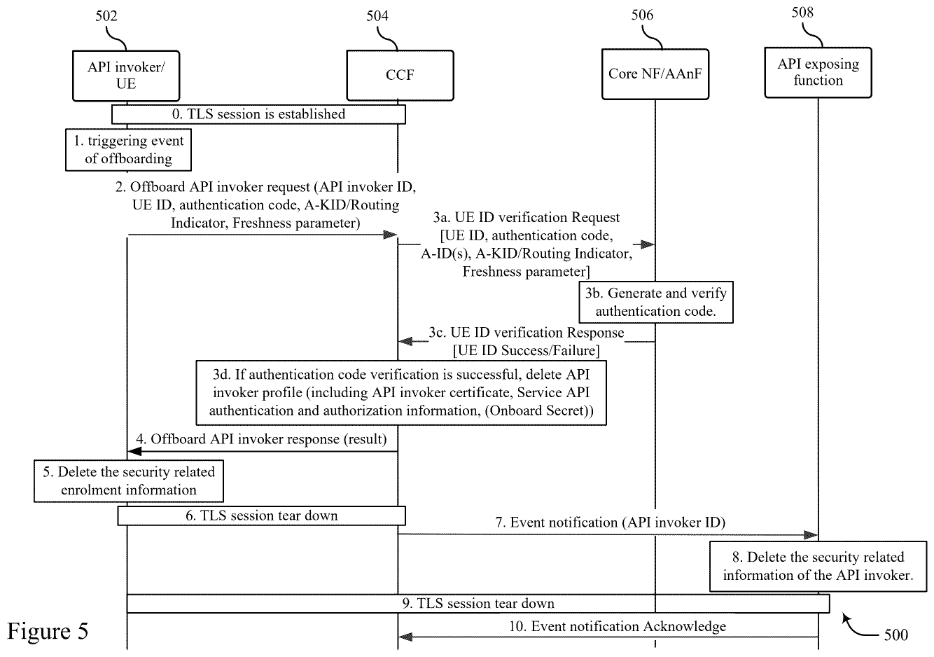

FIG. 5 illustrates a signaling diagram 500 in accordance with aspects of the present disclosure. The signaling diagram 500, for example, illustrates security procedures for API invoker offboarding. In implementations, one condition for the described API invoker offboarding is that an API invoker/UE has been successfully onboarded, such as described throughout this disclosure.

At step 0, a TLS session is established successfully between an API invoker/UE 502 and a CCF 504. At Step 1, an event occurs at the API invoker/UE 502 to trigger the offboarding action. At Step 2, the API invoker/UE 502 sends an Offboard API invoker request message to the CCF 504, including the CCF specific API invoker ID which was assigned by the CCF 504 during the onboarding procedure along with offboarding type ((‘User/Subscriber Indication/UE service based’)), UE ID (e.g., GPSI/SUPI), authentication code, Application Identifier(s) (A-ID(s)), AKMA Key Identifier (A-KID)/Routing Indicator (e.g., to route the authentication code verification related request to the correct NF/AF in the network to fetch a related UE security context related to UE ID e.g., a NF can be an AUSF or AAnF or it can an AF), and freshness parameter which can be used in the authentication code generation.

In examples, the authentication code can be generated as hash and/or MAC of different information, such as UE security context, UE ID (e.g., GPSI/SUPI), freshness parameter (e.g., Nonce/Random number/Counter), Routing Indicator/A-KID, and A-ID(s)). The UE security context used in the authentication code generation can be one or more of AUSF key, AKMA Key, or AF Key, respectively. The AKMA AF/AF can identify the AAnF serving the UE from the A-KID to fetch the AF key or a related AKMA key for the authentication code generation.

At Step 3a, the CCF 504 sends a request (e.g., UE ID verification request/authentication verification request) to the Core NF/AAnF/AF 506 which includes the UE ID (e.g., GPSI/SUPI), authentication code indication, Application Identifier(s) (A-ID(s)), AKMA Key Identifier (A-KID)/Routing Indicator (e.g., to route the authentication code verification related request to the correct NF/AF in the network), and freshness parameter (which can be used in the authentication code generation) as received from the API invoker/UE 502. The CCF 504 can use the routing indicator/A-KID received from the API invoker/UE 502 to send the request (e.g., UE ID verification request/authentication verification request) to the correct Core NF/AAnF/AF which holds the UE context (e.g., AUSF key, AKMA Key or AF Key related to the Application identifier) related to the UE ID (e.g., GPSI/SUPI). At Step 3b, the Core NF/AAnF/AF 506 fetches the UE security context (AUSF key, AKMA Key or AF Key) related to the UE ID (e.g., GPSI/SUPI) and generates the authentication code similar to the API invoker/UE as described in Step 3. At Step 3c, the Core NF/AAnF/AF 506 sends a response (e.g., UE ID verification response/authentication verification response) to the CCF 504 with the authentication code based on the received authentication code indication.

The following described alternative or additional implementations of the Steps 3a-3c of the signaling diagram 500, designated as “Alternative.” At Alternative Step 3a, the CCF 504 sends a request (e.g., UE ID verification request/authentication verification request) to the Core NF/AAnF/AF 506 which includes the UE ID (e.g., GPSI/SUPI), authentication code indication, Application Identifier(s) (A-ID(s)), AKMA Key Identifier (A-KID)/Routing Indicator (e.g., to route the authentication code verification related request to the right NF/AF in the network), freshness parameter (which can be used in the authentication code generation) as received from the API invoker/UE 502. The CCF 504 can use the routing indicator/A-KID received from the API invoker/UE 502 to send the request (e.g., UE ID verification request/authentication verification request) to the correct Core NF/AAnF/AF which holds the UE context (e.g., AUSF key, AKMA Key or AF Key related to the Application identifier) related to the UE ID (e.g., GPSI/SUPI).

At Alternative Step 3b, the Core NF/AAnF/AF 506 fetches the UE security context (AUSF key, AKMA Key, or AF Key) related to the UE ID (e.g., GPSI/SUPI) and generates the authentication code in a similar way to the API invoker/UE 502 as described in Step 2. At Alternative Step 3c, the Core NF/AAnF/AF 506 sends a response (e.g., UE ID verification response/authentication verification response) to the CCF 504 with the authentication code based on the received authentication code indication.

At Step 3d, if the CCF 504 receives success indication in response message from the Core NF/AAnF/AF 506, the CCF 504 can verify the API invoker ID received in Step 2 and check that the corresponding profile exists for the API invoker/UE 502. With successful verification of the API invoker ID and its profile, the CCF 504 can cancel the enrolment of the API invoker/UE 502 and delete the API invoker profile. This can include deletion of API invoker certificate, service API authentication and authorization information, and onboard secret. Based on operator policy, the CCF 504 may retain the information of the offboarded API invoker.

Alternatively, or in addition, in Step 3d, the CCF 504 receives an authentication code in response message from the Core NF/AAnF/AF 506 and the CCF 504 checks if the authentication code received in step 4c from the Core NF/AAnF/AF 506 matches the authentication code received in Step 3 from the API invoker/UE 502. If the match is successful, the CCF 504 continues to perform the API invoker verification and its profile verification as described herein. At Step 4, the CCF 504 sends Offboard API invoker response message, indicating the successful offboarding of the API invoker/UE 502. At Step 5, the API invoker/UE 502 can delete the information, such as API invoker ID, Service API authentication/authorization information, API invoker certificate, and Onboard_Secret.

At Step 6, the CCF 504 can tear down the TLS session with the API invoker/UE 502. At Step 7, the CCF 504 can send an Event notification message to an API exposing function 508 to indicate that the API invoker/UE 502 is no longer valid. At Step 8, the API exposing function 508 can delete the security related information associated with the API invoker/UE 502 based on procedures to authenticate the API invoker, e.g. AEF_{PSK} (TLS-Pre-Shared Key (PSK) method), root certificate to validate the API invoker certificate (Public Key Infrastructure (PKI) method), access token (OAuth 2.0 method). At Step 9, the API exposing function 508 can tear down the TLS connection with the API invoker/UE 502. At Step 10, the API exposing function 508 can return an Event notification acknowledge message to the CCF 504 to indicate that the security related information associated with the API invoker/UE 502 is successfully deleted and thus the API invoker/UE 502 is no longer an acknowledged user.

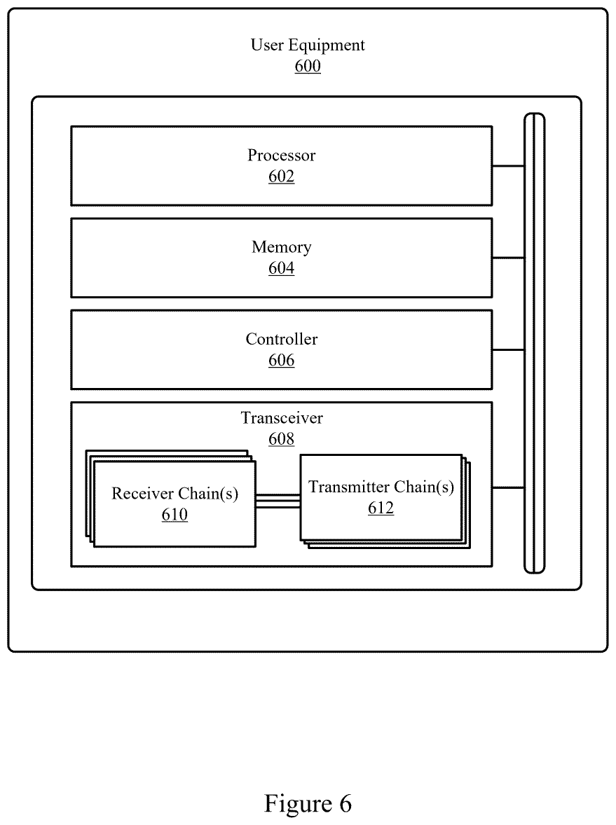

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for transmitting an onboard API invoker request including a UE identifier, a first authentication code, and a first freshness parameter; and receiving an onboard API invoker response including an API invoker certificate associated with the UE identifier and one or more A-IDs, and an API invoker secret associated with the UE identifier and one or more A-IDs.

Additionally, the UE 600 may be configured to support any one or combination of where the UE identifier includes one or more of a GPSI or a SUPI, and the first freshness parameter includes one or more of a nonce number, a random number, or a counter; the onboard API invoker request further includes one or more of an A-KID or a routing indicator; the routing indicator includes routing information to route verification of the first authentication code to one or more of a network function or an application function; generating the first authentication code as one or more of: a hash of one or more of a UE security context, the UE identifier, the first freshness parameter, the routing indicator, the A-KID, or an A-ID; or a MAC of one or more of the UE security context, the UE identifier, the first freshness parameter, the routing indicator, the A-KID, or the A-ID; the UE security context includes one or more of an AUSF key, an AKMA key, or an AF key; transmitting an offboard API invoker request including the UE identifier, a third authentication code, and a second freshness parameter; and receiving, based at least in part on the offboard API invoker request, an offboard API invoker response.

Additionally, or alternatively, the UE 600 may support at least one memory (e.g., the memory 604) and at least one processor (e.g., the processor 602) coupled with the at least one memory and configured to cause the UE to transmit an onboard API invoker request including a UE identifier, a first authentication code, and a first freshness parameter; and receive an onboard API invoker response including an API invoker certificate associated with the UE identifier and one or more A-IDs, and an API invoker secret associated with the UE identifier and one or more A-IDs.

Additionally, the UE 600 may be configured to support any one or combination of where the UE identifier includes one or more of a GPSI or a SUPI, and the first freshness parameter includes one or more of a nonce number, a random number, or a counter; the onboard API invoker request further includes one or more of an A-KID or a routing indicator; the routing indicator includes routing information to route verification of the first authentication code to one or more of a network function or an application function; the at least one processor is configured to cause the UE to generate the first authentication code as one or more of: a hash of one or more of a UE security context, the UE identifier, the first freshness parameter, the routing indicator, the A-KID, or an A-ID; or a MAC of one or more of the UE security context, the UE identifier, the first freshness parameter, the routing indicator, the A-KID, or the A-ID; the UE security context includes one or more of an AUSF key, an AKMA key, or an AF key; the at least one processor is configured to cause the UE to: transmit an offboard API invoker request including the UE identifier, a third authentication code, and a second freshness parameter; and receive, based at least in part on the offboard API invoker request, an offboard API invoker response.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

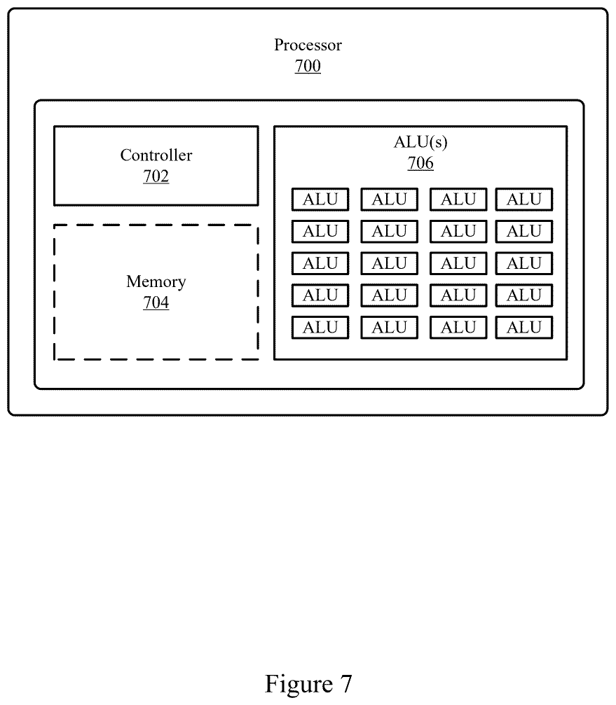

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to transmit an onboard API invoker request including a UE identifier, a first authentication code, and a first freshness parameter; and receive an onboard API invoker response including an API invoker certificate associated with the UE identifier and one or more A-IDs, and an API invoker secret associated with the UE identifier and one or more A-IDs.

Additionally, the processor 700 may be configured to or operable to support any one or combination of where the UE identifier includes one or more of a GPSI or a SUPI, and the first freshness parameter includes one or more of a nonce number, a random number, or a counter; the onboard API invoker request further includes one or more of an A-KID or a routing indicator; the routing indicator includes routing information to route verification of the first authentication code to one or more of a network function or an application function; the at least one controller is configured to cause the processor to generate the first authentication code as one or more of: a hash of one or more of a UE security context, the UE identifier, the first freshness parameter, the routing indicator, the A-KID, or an A-ID; or a MAC of one or more of the UE security context, the UE identifier, the first freshness parameter, the routing indicator, the A-KID, or the A-ID; the UE security context includes one or more of an AUSF key, an AKMA key, or an AF key; the at least one controller is configured to cause the processor to: transmit an offboard API invoker request including the UE identifier, a third authentication code, and a second freshness parameter; and receive, based at least in part on the offboard API invoker request, an offboard API invoker response.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive an onboard API invoker request including a UE identifier, a first authentication code, and a first freshness parameter; communicate a first UE identifier verification request including the UE identifier, one or more of the first authentication code or an authentication code indication, and the first freshness parameter; receive a first UE identifier verification response based at least in part on information included in the first UE identifier verification request; and transmit, based at least in part on the first UE identifier verification response, an onboard API invoker response.

Additionally, the processor 700 may be configured to or operable to support any one or combination of where the onboard API invoker request further includes one or more of an A-KID or a routing indicator, and where the first UE identifier verification request is communicated based at least in part on the one or more of the A-KID or the routing indicator; the first UE identifier verification response includes an indication of whether the first authentication code is successfully verified; the first UE identifier verification response includes the UE identifier and a second authentication code, and where the at least one controller is configured to cause the processor to: verify the first authentication code based at least in part on a comparison of the first authentication code to the second authentication code; the at least one controller is configured to cause the processor to generate an API invoker profile for the UE identifier based at least in part on a GPSI and one or more A-IDs; the onboard API invoker response includes an onboard secret associated with the UE identifier and one or more A-IDs; the at least one controller is configured to cause the processor to: receive an offboard API invoker request including the UE identifier, a third authentication code, and a second freshness parameter; communicate a second UE identifier verification request including the UE identifier, the third authentication code, and the second freshness parameter; receive a second UE identifier verification response based at least in part on information included in the second UE identifier verification request; and transmit, based at least in part on the second UE identifier verification response, an offboard API invoker response.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to receive a UE identifier verification request including a UE identifier, a first authentication code, and a first freshness parameter; generate a second authentication code based at least in part on the UE identifier and a UE security context associated with the UE identifier; and communicate a UE identifier verification response based at least in part on the second authentication code.

Additionally, the processor 700 may be configured to or operable to support any one or combination of where the second authentication code is generated based at least in part on a security context associated with the UE identifier; the at least one controller is configured to cause the processor to: verify the first authentication code based at least in part on a comparison of the first authentication code to the second authentication code; the UE identifier verification response includes an indication of whether the first authentication code is successfully verified; the UE identifier verification response includes the second authentication code.

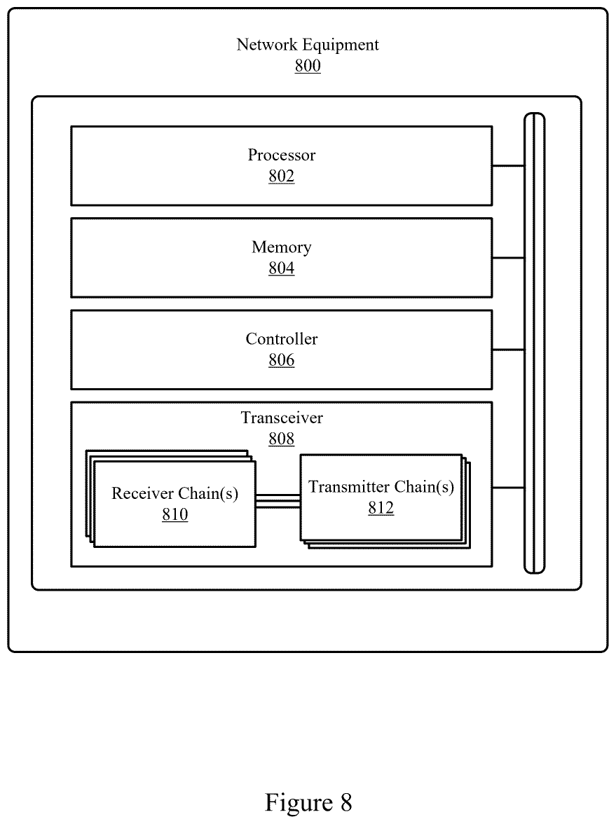

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

The NE 800 may be configured to or operable to support a means for receiving an onboard API invoker request including a UE identifier, a first authentication code, and a first freshness parameter; communicating a first UE identifier verification request including the UE identifier, one or more of the first authentication code or an authentication code indication, and the first freshness parameter; receiving a first UE identifier verification response based at least in part on information included in the first UE identifier verification request; and transmitting, based at least in part on the first UE identifier verification response, an onboard API invoker response.

Additionally, the NE 800 may be configured to or operable to support any one or combination of where the onboard API invoker request further includes one or more of an A-KID or a routing indicator, and where the first UE identifier verification request is communicated based at least in part on the one or more of the A-KID or the routing indicator; the first UE identifier verification response includes an indication of whether the first authentication code is successfully verified; the first UE identifier verification response includes the UE identifier and a second authentication code, and verifying the first authentication code based at least in part on a comparison of the first authentication code to the second authentication code; generating an API invoker profile for the UE identifier based at least in part on a GPSI and one or more A-IDs; the onboard API invoker response includes an onboard secret associated with the UE identifier and one or more A-IDs; receiving an offboard API invoker request including the UE identifier, a third authentication code, and a second freshness parameter; communicating a second UE identifier verification request including the UE identifier, the third authentication code, and the second freshness parameter; receiving a second UE identifier verification response based at least in part on information included in the second UE identifier verification request; and transmitting, based at least in part on the second UE identifier verification response, an offboard API invoker response.

Additionally, or alternatively, the NE 800 may support at least one memory (e.g., the memory 804) and at least one processor (e.g., the processor 802) coupled with the at least one memory and configured to cause the NE to receive an onboard API invoker request including a UE identifier, a first authentication code, and a first freshness parameter; communicate a first UE identifier verification request including the UE identifier, one or more of the first authentication code or an authentication code indication, and the first freshness parameter; receive a first UE identifier verification response based at least in part on information included in the first UE identifier verification request; and transmit, based at least in part on the first UE identifier verification response, an onboard API invoker response.

Additionally, the NE 800 may be configured to support any one or combination of where the onboard API invoker request further includes one or more of an A-KID or a routing indicator, and where the first UE identifier verification request is communicated based at least in part on the one or more of the A-KID or the routing indicator; the first UE identifier verification response includes an indication of whether the first authentication code is successfully verified; the first UE identifier verification response includes the UE identifier and a second authentication code, and where the at least one processor is configured to cause the NE to: verify the first authentication code based at least in part on a comparison of the first authentication code to the second authentication code; the at least one processor is configured to cause the NE to generate an API invoker profile for the UE identifier based at least in part on a GPSI and one or more A-IDs; the onboard API invoker response includes an onboard secret associated with the UE identifier and one or more A-IDs; the at least one processor is configured to cause the NE to: receive an offboard API invoker request including the UE identifier, a third authentication code, and a second freshness parameter; communicate a second UE identifier verification request including the UE identifier, the third authentication code, and the second freshness parameter; receive a second UE identifier verification response based at least in part on information included in the second UE identifier verification request; and transmit, based at least in part on the second UE identifier verification response, an offboard API invoker response.

The NE 800 may be configured to or operable to support a means for receiving a UE identifier verification request including a UE identifier, a first authentication code, and a first freshness parameter; generating a second authentication code based at least in part on the UE identifier and a UE security context associated with the UE identifier; and communicating a UE identifier verification response based at least in part on the second authentication code.

Additionally, the NE 800 may be configured to or operable to support any one or combination of where the second authentication code is generated based at least in part on a security context associated with the UE identifier; verifying the first authentication code based at least in part on a comparison of the first authentication code to the second authentication code; the UE identifier verification response includes an indication of whether the first authentication code is successfully verified; the UE identifier verification response includes the second authentication code.

Additionally, or alternatively, the NE 800 may support at least one memory (e.g., the memory 804) and at least one processor (e.g., the processor 802) coupled with the at least one memory and configured to cause the NE to receive a UE identifier verification request including a UE identifier, a first authentication code, and a first freshness parameter; generate a second authentication code based at least in part on the UE identifier and a UE security context associated with the UE identifier; and communicate a UE identifier verification response based at least in part on the second authentication code.

Additionally, the NE 800 may be configured to support any one or combination of where the second authentication code is generated based at least in part on a security context associated with the UE identifier; the at least one processor is configured to cause the NE to: verify the first authentication code based at least in part on a comparison of the first authentication code to the second authentication code; the UE identifier verification response includes an indication of whether the first authentication code is successfully verified; the UE identifier verification response includes the second authentication code.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

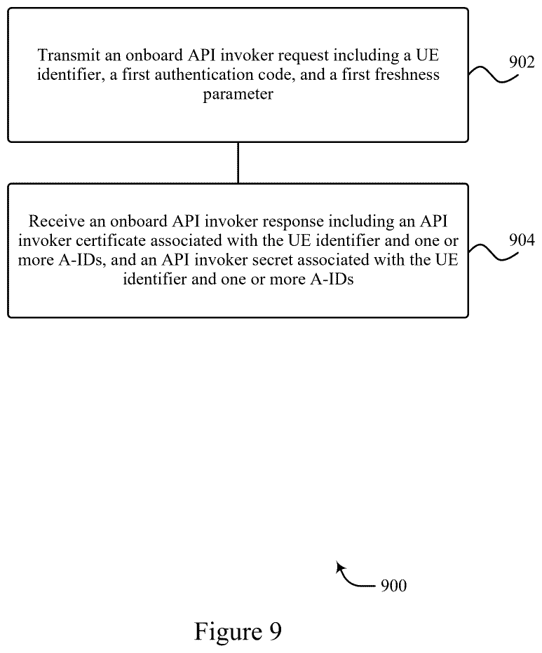

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include transmitting an onboard API invoker request including a UE identifier, a first authentication code, and a first freshness parameter. The operations of 902 may be performed in accordance with examples as described herein. In some implementations, aspects of the operations of 902 may be performed by a UE as described with reference to FIG. 6.

At 904, the method may include receiving an onboard API invoker response including an API invoker certificate associated with the UE identifier and one or more A-IDs, and an API invoker secret associated with the UE identifier and one or more A-IDs. The operations of 904 may be performed in accordance with examples as described herein. In some implementations, aspects of the operations of 904 may be performed by a UE as described with reference to FIG. 6.

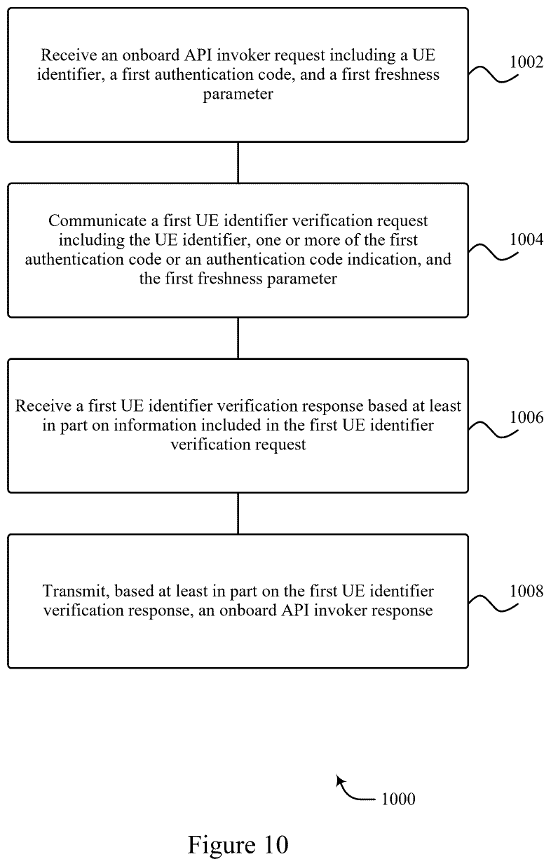

FIG. 10 illustrates a flowchart of a method 1000 in accordance with aspects of the present disclosure. The operations of the method may be implemented by a network entity (e.g., a NE, a network function, an infrastructure component) as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 1002, the method may include receiving an onboard API invoker request including a UE identifier, a first authentication code, and a first freshness parameter. The operations of 1002 may be performed in accordance with examples as described herein. In some implementations, aspects of the operations of 1002 may be performed by an NE as described with reference to FIG. 8.

At 1004, the method may include communicating a first UE identifier verification request including the UE identifier, one or more of the first authentication code or an authentication code indication, and the first freshness parameter. The operations of 1004 may be performed in accordance with examples as described herein. In some implementations, aspects of the operations of 1004 may be performed by an NE as described with reference to FIG. 8.

At 1006, the method may include receiving a first UE identifier verification response based at least in part on information included in the first UE identifier verification request. The operations of 1006 may be performed in accordance with examples as described herein. In some implementations, aspects of the operations of 1006 may be performed an NE as described with reference to FIG. 8.

At 1008, the method may include transmitting, based at least in part on the first UE identifier verification response, an onboard API invoker response. The operations of 1008 may be performed in accordance with examples as described herein. In some implementations, aspects of the operations of 1008 may be performed an NE as described with reference to FIG. 8.

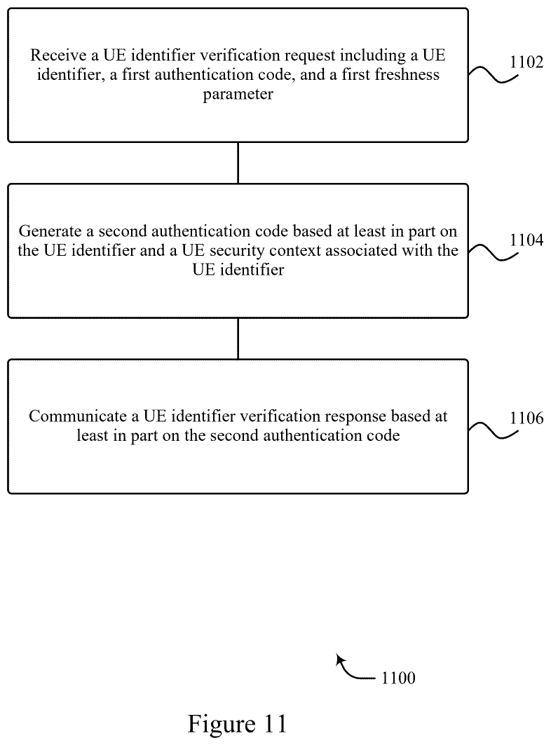

FIG. 11 illustrates a flowchart of a method 1100 in accordance with aspects of the present disclosure. The operations of the method may be implemented by a network entity (e.g., a NE, a network function, an infrastructure component) as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 1102, the method may include receiving a UE identifier verification request including a UE identifier, a first authentication code, and a first freshness parameter. The operations of 1102 may be performed in accordance with examples as described herein. In some implementations, aspects of the operations of 1102 may be performed by an NE as described with reference to FIG. 8.

At 1104, the method may include generating a second authentication code based at least in part on the UE identifier and a UE security context associated with the UE identifier. The operations of 1104 may be performed in accordance with examples as described herein. In some implementations, aspects of the operations of 1104 may be performed by an NE as described with reference to FIG. 8.

At 1106, the method may include communicating a UE identifier verification response based at least in part on the second authentication code. The operations of 1106 may be performed in accordance with examples as described herein. In some implementations, aspects of the operations of 1106 may be performed an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit an onboard application programming interface (API) invoker request comprising a UE identifier, a first authentication code, and a first freshness parameter; and
receive an onboard API invoker response comprising an API invoker certificate associated with the UE identifier and one or more application identifiers (A-IDs), and an API invoker secret associated with the UE identifier and one or more A-IDs.

2. The UE of claim 1, wherein the UE identifier comprises one or more of a generic public subscription identifier (GPSI) or a subscription permanent identifier (SUPI), and the first freshness parameter comprises one or more of a nonce number, a random number, or a counter.

3. The UE of claim 1, wherein the onboard API invoker request further comprises one or more of an authentication and key management for applications (AKMA) Key Identifier (A-KID) or a routing indicator.

4. The UE of claim 3, wherein the routing indicator comprises routing information to route verification of the first authentication code to one or more of a network function or an application function.

5. The UE of claim 3, wherein the at least one processor is configured to cause the UE to generate the first authentication code as one or more of:
a hash of one or more of a UE security context, the UE identifier, the first freshness parameter, the routing indicator, the A-KID, or an A-ID; or
a message authentication code (MAC) of one or more of the UE security context, the UE identifier, the first freshness parameter, the routing indicator, the A-KID, or the A-ID.

6. The UE of claim 5, wherein the UE security context comprises one or more of an authentication server function (AUSF) key, an AKMA key, or an application function (AF) key.

7. The UE of claim 1, wherein the at least one processor is configured to cause the UE to:
transmit an offboard API invoker request comprising the UE identifier, a third authentication code, and a second freshness parameter; and
receive, based at least in part on the offboard API invoker request, an offboard API invoker response.

8. A first network entity for wireless communication, comprising:
at least one memory; and
at least one processor coupled with the at least one memory and configured to cause the first network entity to:
receive an onboard application programming interface (API) invoker request comprising a user equipment (UE) identifier, a first authentication code, and a first freshness parameter;
communicate a first UE identifier verification request comprising the UE identifier, one or more of the first authentication code or an authentication code indication, and the first freshness parameter;
receive a first UE identifier verification response based at least in part on information included in the first UE identifier verification request; and
transmit, based at least in part on the first UE identifier verification response, an onboard API invoker response.

9. The first network entity of claim 8, wherein the onboard API invoker request further comprises one or more of an authentication and key management for applications (AKMA) Key Identifier (A-KID) or a routing indicator, and wherein the first UE identifier verification request is communicated based at least in part on the one or more of the A-KID or the routing indicator.

10. The first network entity of claim 8, wherein the first UE identifier verification response comprises an indication of whether the first authentication code is successfully verified.

11. The first network entity of claim 8, wherein the first UE identifier verification response comprises the UE identifier and a second authentication code, and wherein the at least one processor is configured to cause the first network entity to:
verify the first authentication code based at least in part on a comparison of the first authentication code to the second authentication code.

12. The first network entity of claim 11, wherein the at least one processor is configured to cause the first network entity to generate an API invoker profile for the UE identifier based at least in part on a generic public subscription identifier (GPSI) and one or more application identifiers (A-IDs).

13. The first network entity of claim 8, wherein the onboard API invoker response comprises an onboard secret associated with the UE identifier and one or more application identifiers (A-IDs).

14. The first network entity of claim 8, wherein the at least one processor is configured to cause the first network entity to:
receive an offboard API invoker request comprising the UE identifier, a third authentication code, and a second freshness parameter;
communicate a second UE identifier verification request comprising the UE identifier, the third authentication code, and the second freshness parameter;
receive a second UE identifier verification response based at least in part on information included in the second UE identifier verification request; and
transmit, based at least in part on the second UE identifier verification response, an offboard API invoker response.

15. A second network entity for wireless communication, comprising:
at least one memory; and
at least one processor coupled with the at least one memory and configured to cause the second network entity to:
receive a user equipment (UE) identifier verification request comprising a UE identifier, a first authentication code, and a first freshness parameter;
generate a second authentication code based at least in part on the UE identifier and a UE security context associated with the UE identifier; and
communicate a UE identifier verification response based at least in part on the second authentication code.

16. The second network entity of claim 15, wherein the second authentication code is generated based at least in part on a security context associated with the UE identifier.

17. The second network entity of claim 15, wherein the at least one processor is configured to cause the second network entity to:
verify the first authentication code based at least in part on a comparison of the first authentication code to the second authentication code.

18. The second network entity of claim 17, wherein the UE identifier verification response comprises an indication of whether the first authentication code is successfully verified.

19. The second network entity of claim 15, wherein the UE identifier verification response comprises the second authentication code.

20. A method performed by a user equipment (UE), the method comprising:
transmitting an onboard application programming interface (API) invoker request comprising a UE identifier, a first authentication code, and a first freshness parameter; and
receiving an onboard API invoker response comprising an API invoker certificate associated with the UE identifier and one or more application identifiers (A-IDs), and an API invoker secret associated with the UE identifier and one or more A-IDs.
